(19) United States
(12) Patent Application Publication
(10) Pub. No.: US 2009/0089116 A1
(43) Pub. Date: Apr. 2, 2009

(54) Method and System for Acquiring and Tracking Redeemable Codes

(76) Inventors: Stephen Quirk, Millburn, NJ (US); Colin Meldrum, Berkeley, CA (US); Claude P. Carlier, Hamden, CT (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 11/865,618

(22) Filed: Oct. 1, 2007

(51) Int. Cl. G06Q 30/00; G06Q 10/00

(52) U.S. Cl. 705/7; 705/14

(57) ABSTRACT

Improved approaches to generate, distribute, redeem or return codes are disclosed. The codes can be used (i.e., redeemed) to purchase products from an online store. The codes can be electronically requested and received. In one embodiment, the codes can be acquired from a server via a network. The codes can be content specific codes that are redeemable for particular content, such as specific digital media assets. The codes can be returnable, and royalty obligations that may be due can be adjusted for returns.

### BACKGROUND OF THE INVENTION

1. Field of the Invention

The present invention relates to redeemable codes and, more particularly, to generation, distribution and redemption of redeemable codes.

2. Description of the Related Art

Retail stores, including both brick-and-mortar and online stores, can support gift cards (or prepaid cards). Once activated, the gift cards have a predetermined monetary value. A user with a gift card can use the card to purchase any of the products offered at the retail stores. Often, a particular gift card is associated with a specific retail store such that the gift card can only be used with the specific retail store. When using a gift card at an online store, the user supplies the code appearing on the card to the online store. The online store can validate the code and allow the user to make use of the monetary value of the card.

The ability to purchase digital media items (e.g., songs or movies) for use with digital media players allows owners of the digital media players to efficiently download digital media items onto their players. Gift cards (or prepaid cards) issued for an online store allow any available digital audio and/or video files to be purchased and downloaded. One example of an online store that allows monetary values associated with gift cards to be redeemed for arbitrary media items is the iTunes® online media store owned and operated by Apple Inc. of Cupertino, Calif.

Conventionally, when gift cards are being produced, a batch of codes to be printed on or embedded in the gifts cards (or prepaid cards) are manually requested and received. For example, a compact disc with the batch of codes stored thereon can be supplied to a card manufacturer who prints or embeds the codes on the cards. The codes can be used to authenticate and activate the gift cards. Likewise, when codes (provided on cards or otherwise) are provided for promotional products, such as a free download of any song, the codes are also manually requested and received well in advance. Using one of the codes, a user is able to acquire one free song of their choosing. Unfortunately, however, these largely manual processes can take days to perform and is not suitable for a near real-time online environment.

Thus, there is a need for improved ways to generate, distribute and redeem codes that can be used to purchase produce products from an online store.

### SUMMARY OF THE INVENTION

The invention pertains to methods and systems to generate, distribute, redeem or return codes. The codes can be used (i.e., redeemed) to purchase products from an online store. The codes can be electronically requested and received. In one embodiment, the codes can be acquired from a server via a network. The codes can be content specific codes that are redeemable for particular content, such as specific digital media assets. The codes can be returnable, and royalty obligations that may be due can be adjusted for returns.

The invention can be implemented in numerous ways, including as a method, system, device, or apparatus (including computer readable medium). Several embodiments of the invention are discussed below.

As a computer-implemented method for providing codes that can be redeemed for products, one embodiment of the invention can, for example, include at least the acts of: electronically receiving a request for one or more redeemable codes; determining whether the request for the one or more redeemable codes is approved; automatically generating one or more redeemable codes if it is determined that the request for the one or more redeemable codes is approved; and electronically transmitting the one or more generated codes in response to the request.

As a computer-implemented method for providing codes that can be redeemed online for media items, one embodiment of the invention can, for example, include at least the acts of: providing to a partner an electronic media catalog pertaining to a plurality of media items; receiving an availability request from the partner regarding one or more specified media items; sending to the partner availability and price data for the one or more specified media items; receiving, from the partner, a request for one or more redeemable codes at a price indicated by the price data, each of the one or more redeemable codes being redeemable for one of the specified media items; determining whether the one or more specified media items are available from an online media repository; determining whether the price associated with the request for one or more redeemable codes is authentic; automatically generating one or more redeemable codes if it is determined that the one or more specified media items are available from the online media repository and that the price associated with the request for one or more redeemable codes is authentic; and electronically transmitting the one or more generated codes in response to the requestor.

As a computer-implemented method for redeeming a code for a digital media asset, one embodiment of the invention can, for example, include at least the acts of: receiving a particular code to be redeemed from a code holder, the particular code corresponding to a specific digital media asset; determining whether the particular code is valid; determining whether the particular code has been previously redeemed; and facilitating download of the specific digital media asset to the code holder if the particular code is determined to be valid and not previously redeemed.

As a computer readable medium including at least executable computer program code tangibly stored thereon for providing codes that can be redeemed for products, one embodiment of the invention can, for example, include: computer program code for electronically receiving a request for one or more redeemable codes; computer program code for determining whether the request for the one or more redeemable codes is approved; computer program code for automatically generating one or more redeemable codes if it is determined that the request for the one or more redeemable codes is approved; and computer program code for electronically transmitting the one or more generated codes in response to the request.

As a system for distribution of redeemable codes, one embodiment of the invention can, for example, includes at least: a code server that provides online access to redeemable codes, the code server being configured to receive a request for one or more redeemable codes, generate one or more redeemable codes, and send the one or more generated codes in response to the request; and a financial management system that tracks information regarding usage of the one or more redeemable codes.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of an information delivery system according to one embodiment of the invention.

FIG. 2 is a block diagram of an online media distribution system according to one embodiment of the invention.

FIG. 3 is a flow diagram of a code request process according to one embodiment of the invention.

FIGS. 4A and 4B are flow diagrams of a code request process according to another embodiment of the invention.

FIG. 5 is a flow diagram of a partner online media sales process according to one embodiment of the invention.

FIG. 6 is a flow diagram of a code redemption process according to one embodiment of the invention.

FIG. 7 is a flow diagram of a code invoice process according to one embodiment of the invention.

FIG. 8 is a flow diagram of a royalty prepayment process according to one embodiment of the invention.

FIG. 9 is a flow diagram of a code return process according to one embodiment of the invention.

### DETAILED DESCRIPTION OF THE INVENTION

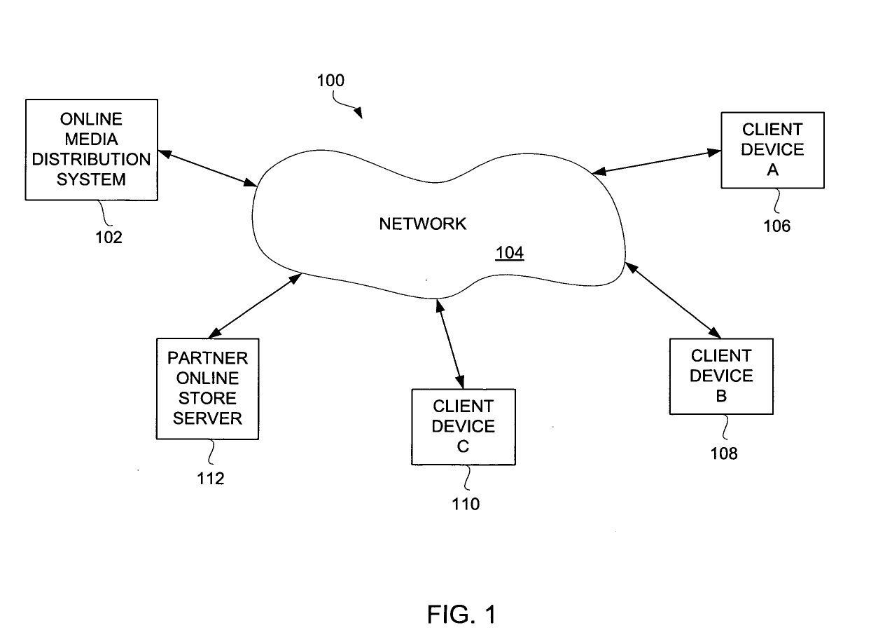

Embodiments of the invention are discussed below with reference to FIGS. 1-9. However, those skilled in the art will readily appreciate that the detailed description given herein with respect to these figures is for explanatory purposes as the invention extends beyond these limited embodiments.

The invention pertains to methods and systems to generate, distribute, redeem or return codes. The codes can be used (i.e., redeemed) to purchase products from an online store. The codes can be electronically requested and received. In one embodiment, the codes can be acquired from a server via a network. The codes can be content specific codes that are redeemable for particular content, such as specific digital media assets. The codes can be returnable, and royalty obligations that may be due can be adjusted for returns.

FIG. 1 is a block diagram of an information delivery system 100 according to one embodiment of the invention. The information delivery system 100 has a system of networked server devices that can provide requested information to client devices and can permit client devices to acquire digital media assets.

The information delivery system 100 includes an online media distribution system 102. The online media distribution system 102 can host an online media store. The online media store can permit uses to browse, search, preview or purchase digital media assets (e.g., digital media items). The online media distribution system 102 is coupled to a network 104. The network 104 is, for example, a data network. More particularly, the network 104 can represent a wide area network or a global network. For example, the network 104 can pertain to a private network or a public network. One example of a global public network is the Internet.

The information delivery system 100 also supports a plurality of client devices that are able to couple to the network 104. As illustrated in FIG. 1, the client devices can be represented by client device A 106, client device B 108 and client device C 110. Any of the client devices can access the online media store server 102 via the network 104. The client devices can be of different capacity, size or form factor. For example, the client devices can pertain to an electronic device. The electronic device can, for example, correspond to a portable digital assistant, a multi-function portable electronic devices, a handheld electronic devices, a portable computing device, a stationary computing device (e.g., desktop computer), and the like.

The information delivery system 100 also includes a partner online store server 112 that couples to the network 104. The partner online store server 112 can host a partner online store. The partner online store is a store that can offer products or services that are related or unrelated to the digital media assets available form the online media store. Hence, when a particular one of the client devices 106, 108 or 110 makes a request for media item information from the online media distribution system 102, the online media distribution system 102 can provide a response to the particular client device. The response can provide the digital media asset from the online media store.

A partner operating the partner online store can obtain one or more codes. For example, the partner online store can obtain the one or more codes from the online media distribution system 102. These codes are redeemable at the online media store to acquire digital content for digital media assets (e.g., media items) from the online media store. The partner online store can sell or otherwise distribute such redeemable codes to users of the partner online store. The users can then redeem codes acquired from the partner online store at the online media store. The online media distribution system 102 can not only make codes available over a network but can also store tracking, billing and invoicing information concerning sale and redemption of the codes.

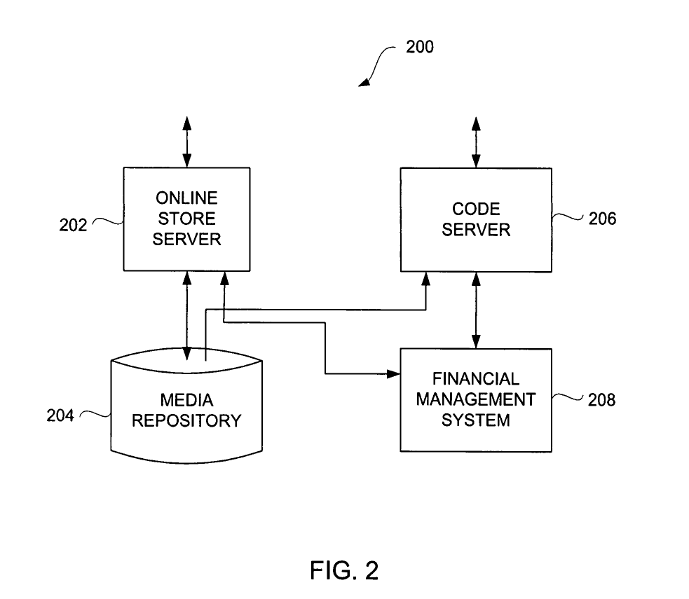

FIG. 2 is a block diagram of an online media distribution system 200 according to one embodiment of the invention. The online media distribution system 200 is, for example, suitable for use as some or all of the online media distribution system 102 illustrated in FIG. 1.

The online media distribution system 200 includes an online store server 202 that hosts an online media store. The online media store hosted by the online store server 202 can offer numerous digital media assets (i.e., media items) for sale (including rental). The digital media assets can be stored in a media repository 204. In addition, the online media distribution system 200 can include a code server 206 that manages the distribution of codes to various requesting third parties. The code server 206 can interact with a financial management system 208 that manages financial considerations regarding the sale, distribution, redemption and return of codes. In one embodiment, each of the codes is a content specific code (CSC) that corresponds to a particular digital media asset (particular media item). Hence, in one embodiment, a third party (e.g., partner) can request one or more codes from the code server 206. The financial management system 208 can manage invoicing of the third-party for the codes. The third party can then distribute or resell the codes to end-users. The end users can then in turn access the online media store hosted by the online store server 202 and utilize the codes to acquire particular digital media assets. Typically, the codes enable the end-users to acquire the particular digital media assets without further cost.

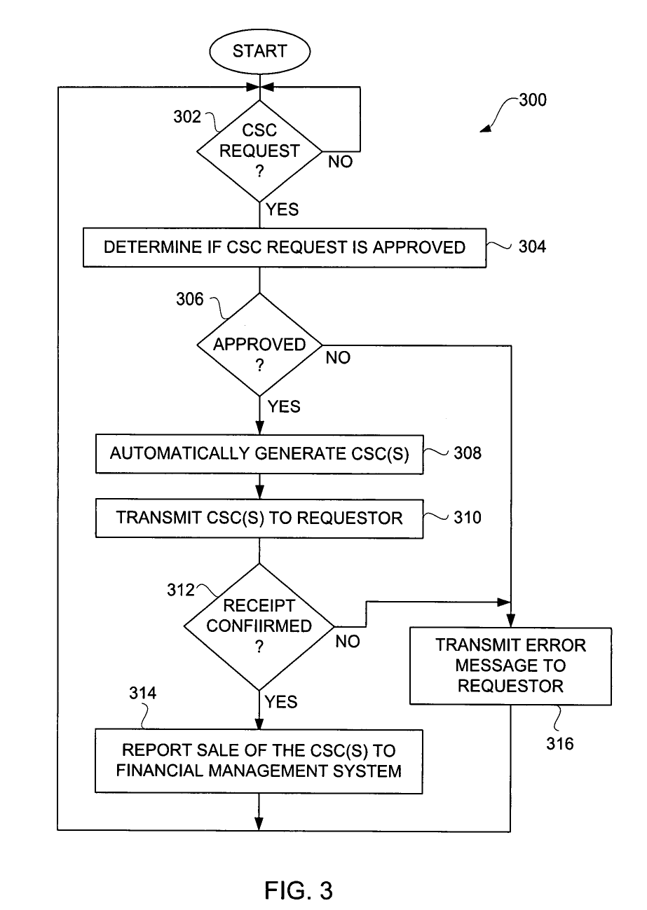

FIG. 3 is a flow diagram of a code request process 300 according to one embodiment of the invention. The code request process 300 is, for example, performed by a code server, such as the code server 206 illustrated in FIG. 2.

The code request process 300 can begin with a decision 302 that determines whether a content specific code (CSC) has been requested by a requester. A requester can refer to a user, a client device or a computer program. When the decision 302 determines that a content specific code has not been requested, the code request process 300 awaits such a request. Once the decision 302 determines that a content specific code has been requested, it is determined 304 whether the content specific code request is approved. The approval of the content specific code request can allow the code server 206 to determine whether the content specific code in requested is still available to the requester. A decision 306 can determine whether the content specific code request is approved.

When the decision 306 determines that the content specific code request is approved, one or more content specific codes can be automatically generated 308. Each content specific code is specifically associated with a particular digital media asset. These content specific codes are unique identifiers that can be individually activated, redeemed, tracked and deactivated as appropriate. The content specific codes can be transmitted 310 to the requestor. Here, the code server can receive the content specific code request via a network (such as the Internet) and then transmit 310 the content specific codes to the requestor via the network. A decision 312 can then determine whether the requestor has confirmed receipt of the content specific codes. When the decision 312 determines that the requester has confirmed receipt of the content specific codes, sale of the content specific codes to the requestor can be reported 314 to a financial management system. For example, the financial management system can be the financial management system 208 illustrated in FIG. 2. On the other hand, when the decision 314 determines that the requester has not confirmed receipt of the content specific codes, it is assumed that the requestor did not properly receive the requested content specific codes. Hence, an error message can be transmitted 316 to the requester. Following the blocks 314 and 316, the code request process can return to repeat the decision 302 so that a subsequent content specific code request can be processed in a similar manner.

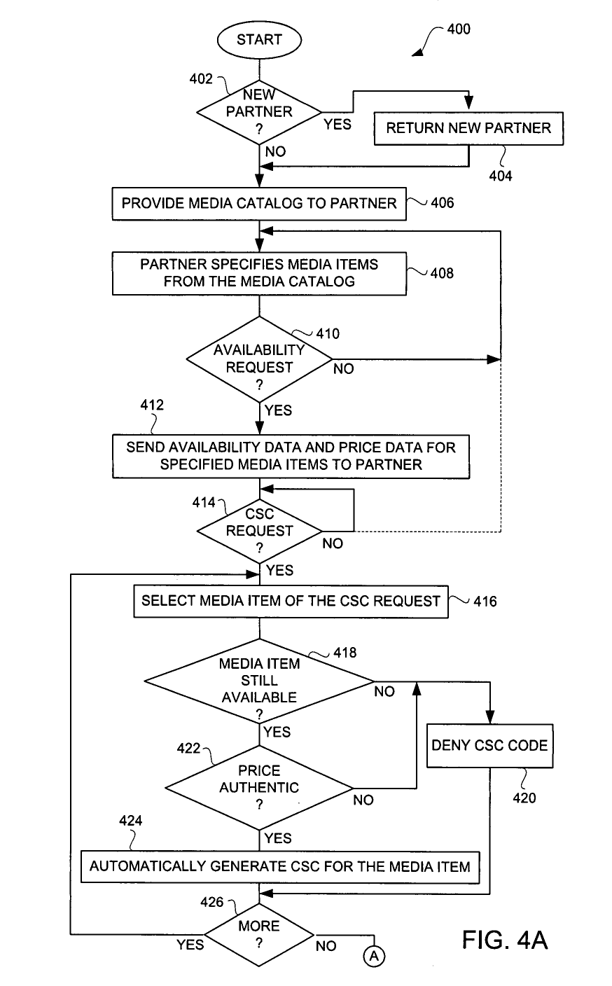

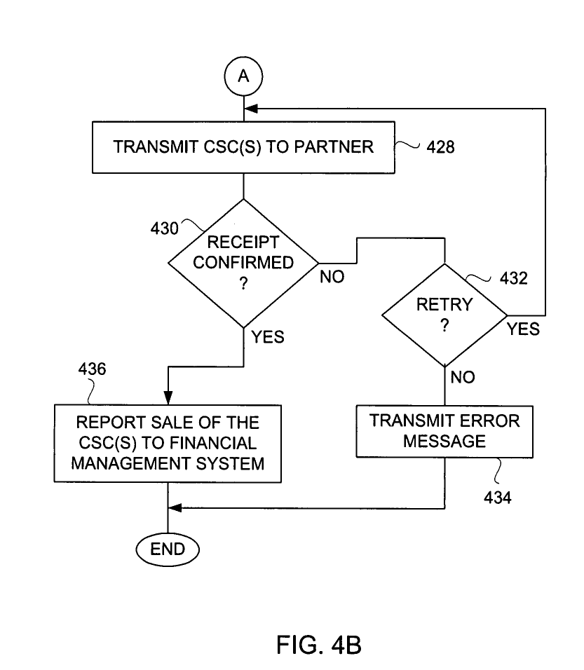

FIGS. 4A and 4B are flow diagrams of a code request process 400 according to another embodiment of the invention. The code request process 400 is, for example, performed by a code server, such as the code server 206 illustrated in FIG. 2.

The code request process 400 can begin with a decision 402. The decision 402 can determine whether a new partner desires to utilize the code service offered by the code server. When the decision 402 determines that a new partner does desire to utilize the code service, the new partner can be setup 404. The setup 404 can provide electronic access and use of the code service. Following the block 404, or following the decision 402 when the partner desiring to utilize the code service is not a new partner but a previously setup the partner, the code request process 400 can continue.

When the code request process 400 continues, a media catalog can be provided 406 to the partner. The media catalog provides a listing of media items that are available from an online media store, such as the online media store hosted by the online store server 202. The partner can then specify 408 one or more media items from the media catalog. Here, the partner specifies 408 one or more specific media items for which the partner desires to receive content specific codes that the partner will sell or otherwise distribute to its end-users. Next, a decision 410 determines whether an availability request concerning the specified media items has been made. When the decision 410 determines that the partner has not made an availability request, the code request process 400 can return to repeat the block 408. Alternatively, when the decision 410 determines that an availability request has been made, availability data and price data for the specified media items can be sent 412 to the partner. In one implementation, the availability data and price data for the specified media items informed the partner as to whether or not content specific codes corresponding to the specified media items are currently available as well as the price for the content specific codes.

Next, a decision 414 can determine whether a content specific code request has been received. When the decision 414 determines that a content specific code request has not been received, the code request process 400 can await a content specific code request or can return to the block 408 so that the partner can specify other media items.

When the decision 414 determines that a content specific code request has been received, a media item identified by the content specific code request is selected 416. A decision 418 can then determines whether the selected media item is still available. For example, the code server can determine whether the selected media items is still available by checking the media repository 204. When the decision 418 determines that the selected media item is not currently available, the content specific code for the selected media item is denied 420.

On the other hand, when the decision 418 determines that the selected media item is still available, a decision 422 determines whether the price requested by the content specific code request is an authentic price. Here, the price should be the price that was previously provided to the partner in response to an availability request (block 412). As an example, the price can be authenticated by using a digital signature or other cryptographic technique. The price provided at block 412 can be a quoted price for which the requestor can acquire a content specific code. The authentication can ensure that the requested price was a price that was previous quoted. Additionally, quoted prices can expire after a period of time so the decision 422 can also confirm that the quoted price is still valid. When the decision 422 determines that the price requested is authentic, a content specific code can be automatically generated 424 for the selected media item. Alternatively, when the decision 422 determines that the price requested is not authentic, the content specific code for the selected media item can be denied 420.

Following the blocks 420 and 424, a decision 426 can determine whether more media items are identified by the content specific code request. When the decision 426 determines that the content specific code request does identify more media items, then the code request process 400 can return to repeat the block 416 and subsequent blocks so that a content specific code can be generated or denied for a next selected media item.

Alternatively, when the decision 426 determines that there are no more media items to be processed, the resulting content specific codes can be transmitted 428 to the partner. A decision 430 can then determine whether the partner has confirmed receipt of the content specific codes. When the decision 430 determines that confirmation of the content specific codes has not been received, a decision 432 can determine whether to retry the transmission of the content specific codes. When the decision 432 determines that the transmission should be retried, the code request process 400 can return to repeat the block 428 so that the content specific codes can be again transmitted 428 to the partner. Alternatively, when the decision 432 determines that the transmission of the content specific codes should not be retried, an error message can be transmitted 434 to the partner. On the other hand, when the decision 430 determines that receipt of the content specific codes has been confirmed by the partner, the sale of the content specific codes to the partner can be reported 436 to a financial management system. Following the blocks 434 and 436, the code request process 400 can end.

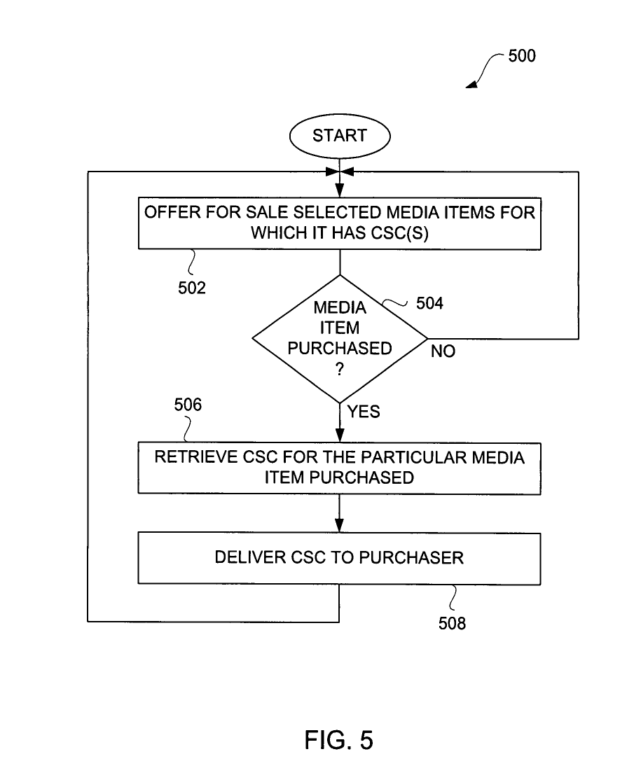

FIG. 5 is a flow diagram of a partner online media sales process 500 according to one embodiment of the invention. The partner online media sales process 500 is, for example, processing that can be performed by a partner online store server, such as the partner online store server 112 illustrated in FIG. 1.

The partner online media sales process 500 can offer 502 for sale selected media items for which it has content specific codes. For example, the partner online store server can have previously acquired the content specific codes from a code server performing a code request process such as described above in FIG. 3 or FIGS. 4A and 4B. A partner online store hosted by the partner online store server can offer its end-users the ability to acquire digital media assets by use of content specific codes that can be provided to the end-users. The end-users can then utilize the content specific codes to obtain the corresponding digital media assets from an online media store, such as an online media store hosted by the online store server 202 illustrated in FIG. 2.

A decision 504 can then determine whether a media item has been purchased. Here, for example, the decision 504 can determine whether an end-user of the partner online store has purchased a digital media asset. In one embodiment, the partner online store can provide the end-user the ability to purchase a digital media asset. When the decision 504 determines that a media item has not been purchased, the partner online media sales process 500 can return to repeat the block 502 so that the end user can browse the partner online store in anticipation of making a purchase.

Once the decision 504 determines that a media item has been purchased, a content specific code for the particular media item purchased can be retrieved 506. Typically, the partner online media store would have previously acquired various content specific codes for particular digital media assets that it desires to have its end-users purchase. In any case, after the content specific code for the particular media item has been retrieved 506, the content specific code can be delivered 508 to the purchaser. The content specific code can be delivered to the purchaser in a variety of different ways. Typically, the content specific code can be delivered 508 to the purchaser in an electronic fashion, such as through an electronic mail message or through presentation on a webpage provided by the partner online store. Regardless, following the block 508, the partner online media sales process 500 can return to repeat the block 502 so that the same or other end-users can acquire the appropriate content specific codes so as to be able to acquire the corresponding digital media assets.

In another embodiment, the partner online store can offer a digital media asset to the end user without additional charge. Hence, it is not necessary that a digital media asset be purchased in order to obtain a content specific code for a digital media asset. In still another embodiment, the partner online store can offer a digital media asset to the end user if the end user makes another qualifying purchase at the partner online store.

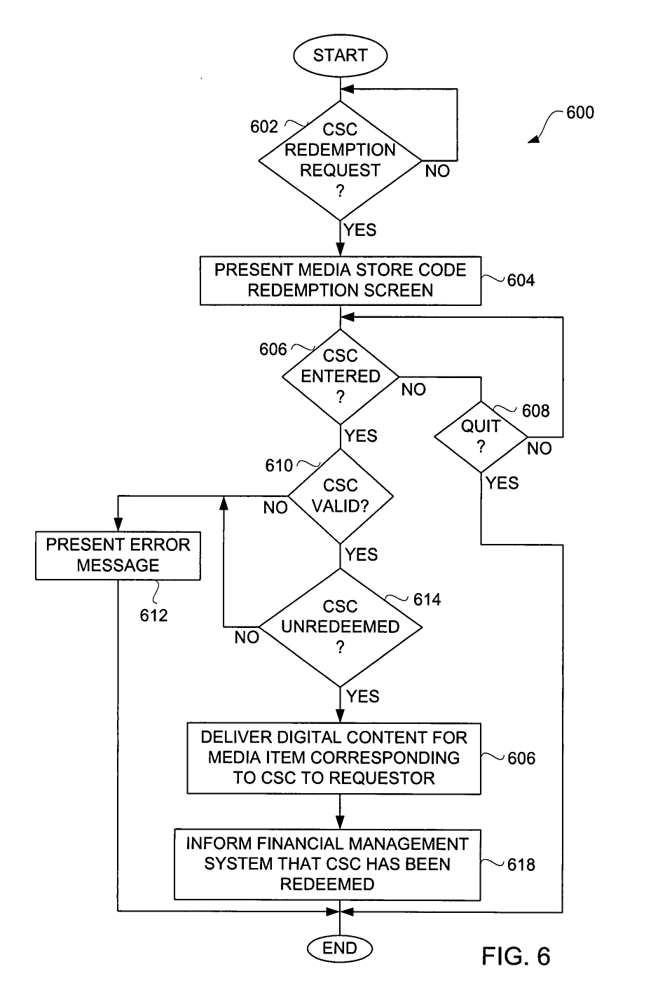

FIG. 6 is a flow diagram of a code redemption process 600 according to one embodiment of the invention. The code redemption process 610 can, for example, be performed by an online store server, such as the online store server 202 illustrated in FIG. 2 that hosts an online media store.

The code redemption process 600 can begin with a decision 602 that determines whether a content specific code redemption request has been received. When the decision 602 determines that a content specific code redemption request has not been received, the code redemption process 600 can await such a request. Once the decision 602 determines that a content specific code redemption request has been received, a media store code redemption screen can be presented 604. An end-user of the online media store can then interact with the media store code redemption screen to enter in a content specific code that they have been previously provided, such as by a partner online store. A decision 606 can determine whether a content specific code has been entered. When the decision 606 determines that a content specific code has not been entered, a decision 608 can determine whether the code redemption process should end. For example, the end-user can close or cancel the media store code redemption screen to cause the code redemption process 600 to end. When the decision 608 determines that the code redemption process 600 should end, then the code redemption process 600 can end. However, when the decision 608 determines that the code redemption process 600 is not to end, the code redemption process 600 can return to repeat the decision 606.

Once the decision 606 determines that a content specific code has been entered, a decision 610 determines whether the content specific code is valid. Here, the content specific code can be examined to determine whether the code is activated. In one implementation, the online store server can interact with a financial management system, such as the financial management system 208, to determine whether the particular content specific code is activated. When the decision 610 determines that the content specific code is not valid, an error message can be presented 612 to the requestor. On the other hand, when the decision 610 determines that the content specific code is valid, a decision 614 can determine whether the particular content specific code is unredeemed. Here, if the content specific code has already been redeemed, the system understands that the content specific code cannot later be again used. Therefore, when the decision 614 determines that the content specific code has been previously redeemed, the code redemption process 600 can present 612 an error message to the end-user.

Alternatively, when the decision 614 determines that the content specific code has not been redeemed, digital content for a media item that corresponds to the particular content specific code can be delivered 616 to the requestor. The financial management system can then be informed 618 that the content specific code has been redeemed. By informing the financial management system that a content specific code has been redeemed, the financial management system can mark the content specific code as “redeemed”. The financial management system can also schedule payment of any royalties that may be due with regard to the sale of the particular media item that corresponds to the particular content specific code. Following the blocks 612 and 618, the code redemption process 610 can end.

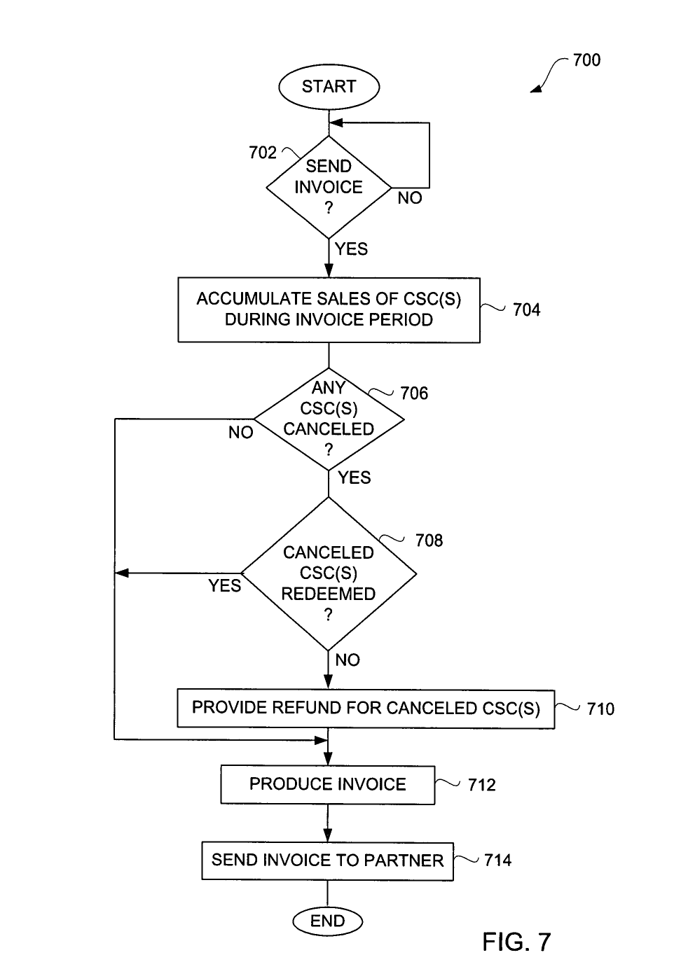

FIG. 7 is a flow diagram of a code invoice process 700 according to one embodiment of the invention. The code invoice process 700 generally involves sending invoices to partners that have previously acquired content specific codes which have been subsequently redeemed for digital media assets. The code invoice process 700 can, for example, be performed by a financial management system, such as the financial management system 208 illustrated in FIG. 2.

The code invoice process 700 can begin with a decision 702 that determines whether an invoice should be sent. In one implementation, invoices can be periodically sent to one or more partners. For example, the code invoice process 700 can operate to send monthly invoices to partners. When the decision 702 determines that an invoice is not to be sent, the code invoice process 700 can await the appropriate time to send an invoice. Once the decision 702 determines that an invoice is to be sent to a particular partner, the code invoice process 700 can continue.

When the decision 702 determines that an invoice is to be sent to a partner, sales of content specific codes can be accumulated 704 for the invoice period. For example, if the invoice period is a month, the sales of content specific codes during that month can be accumulated. Next, the decision 706 determines whether any of the previously sold content specific codes have been canceled. When the decision 706 determines that at least some of the content specific codes have been canceled, then a decision 708 determines whether any of the canceled content specific codes were redeemed. If none of the canceled content specific codes have been redeemed, then a refund for the canceled content specific codes can be provided 710. The block 710 is bypassed with respect to those content specific codes that have been previously canceled or previously redeemed. Accordingly, the partner can be refunded (or credited) for any amounts paid for those canceled content specific codes that have not been previously canceled or redeemed, and the amount of the refund can be the full cost for the content specific codes or some discounted amount. Hence, following the block 710, or its being bypassed, an invoice for the partner can be produced 710. The invoice will bill the partner for the content specific code they have acquired less any refunds (or credits) due for cancelled (or returned) content specific codes. The invoice can then be sent 714 to the partner. In one implementation, the invoice can be electronically transmitted to the partner. Following the block 714, the code invoice process 700 can end.

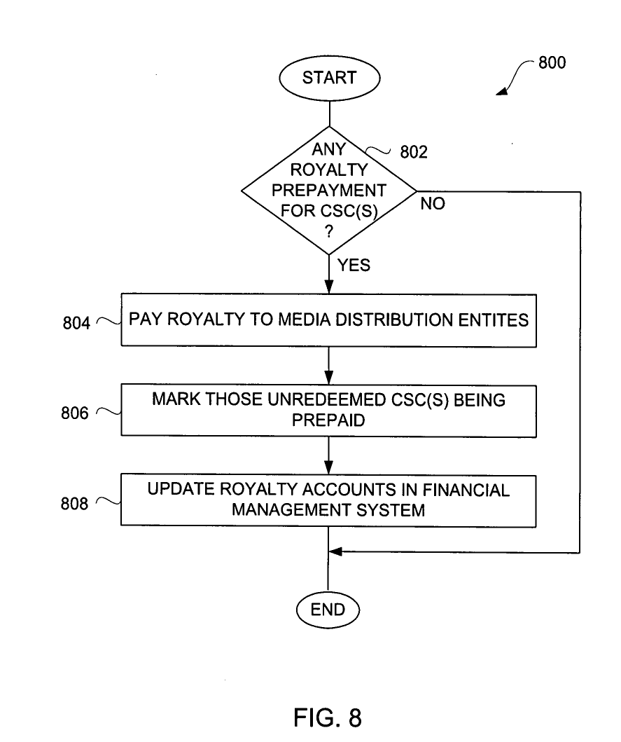

FIG. 8 is a flow diagram of a royalty prepayment process 800 according to one embodiment of the invention. The royalty prepayment process 800 concerns advance payment of royalties for the sale of digital media assets. Here, in some situations, it may be appropriate for the financial management system to pay royalties for some or all of the content specific codes that have been distributed to partners, even though these content specific codes have not yet been redeemed. The royalty payment process 800 can, for example, be performed by a financial management system, such as the financial management system 208 illustrated in FIG. 2.

The royalty prepayment process 800 can begin with a decision 802. The decision 802 can determine whether any royalty prepayment is due for one or more content specific codes that have been previously distributed. For example, it may be advantageous for certain media distribution entities to require that the online media distribution system pay royalties at the end of a fiscal period for content specific codes that have been distributed but not yet redeemed. When the decision 802 determines that a royalty prepayment is due, a royalty for unredeemed content specific codes can be paid 804 to one or more media distribution entities (e.g., music labels). Those unredeemed content specific codes being prepaid can then be marked 806 (e.g., in the financial management system) so that the royalty is not again paid if and when such content specific codes are redeemed. Further, royalty accounts in a financial management system can be updated 808 to reflect that certain of the content specific codes have already paid their royalty obligation. Following the block 808, or directly following the decision 802 when a royalty prepayment for one or more content specific codes is not to be provided, the royalty prepayment process 800 can end.

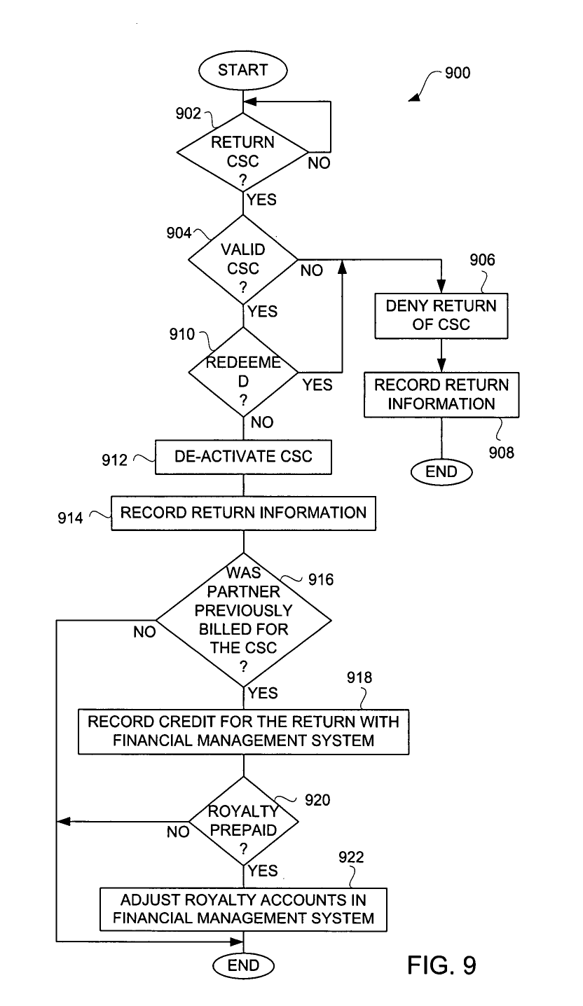

FIG. 9 is a flow diagram of a code return process 900 according to one embodiment of the invention. The code return process 900 is, for example, performed by a financial management system, such as the financial management system 208 illustrated in FIG. 2. The code return process 900 is generally concerned with the return of a previously purchased content specific code.

The code return process 900 can begin with a decision 902 that determines whether return of a content specific code is being requested. When the decision 902 determines that return of a content specific code is not being requested, the code return process 900 can await a request to return of a content specific code. In other words, the code return process 900 can be deemed invoked when there is a request to return a content specific code.

Once the decision 902 determines that there is a request to return a content specific code, a decision 904 can determine whether the content specific code to be returned is valid. For example, the financial management system can be accessed to determine whether the content specific code was previously issued and currently valid (e.g., active). When the decision 904 determines that the content specific code is not valid, then the return of the content specific code can be denied 906. Thereafter, return information can be recorded 908 in the financial management system to indicate the content specific code was attempted to be returned but was denied. Following the block 908, the code return process 900 can end with the return of the content specific code being denied. In addition, when the decision 904 determines that the content specific code is valid, a decision 910 can determine whether the content specific code has been redeemed. When the decision 910 determines that the content specific code has been redeemed, the code return process 900 also denies 906 return of the content specific code and records 908 return information associated therewith.

On the other hand, when the decision 910 determines that the content specific code has not been redeemed, the content specific code can be de-activated (or canceled) 912. In one implementation, the financial management system can indicate whether the content specific code is activated or de-activated. Once de-activated, the content specific code is no longer usable. For example, a user having a content specific code pertaining to a canceled content specific code cannot use the content specific code to access media items from an online media store. Return information descriptive of the content specific code being returned can also be recorded 914.

Moreover, the return of a content specific code can also cause financial adjustments. In this regard, a decision 916 can determine whether the partner (returning the content specific code) was previously billed for the content specific code. When the decision 916 determines that the partner was previously billed for the content specific code, the code return process 900 can record 918 a credit to the partner for the return of the content specific code with the financial management system. A decision 920 can then determine whether a royalty was prepaid. When the decision 920 determines that the royalty has not been paid, the code return process 900 can end. Alternatively, when the decision 920 determines that a royalty has been prepaid, the royalty accounts in the financial management system can be updated 922. For example, the partner returning the content specific code can receive a royalty credit. Following the block 922, the code return process 900 can end. The financial management system can later provide credit or other reports to partners or other entities.

This application also references U.S. patent application Ser. No. ______ [Att.Dkt.No. 101-P608/P5783US1], filed Oct. 1, 2007, entitled “TECHNIQUES FOR CORRELATING EVENTS TO DIGITAL MEDIA ASSETS”, which is herein incorporated by reference.

The digital media assets (i.e., digital media items) can pertain to video items (e.g., video files or movies), audio items (e.g., audio files or audio tracks, such as for songs (music), podcasts or audiobooks), or image items (e.g., photos).

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different aspects, embodiments or implementations may, but need not, yield one or more of the following advantages. One advantage of the invention is that redeemable codes can be requested and received from a server via a network. Another advantage of the invention is that a partner online store can provide redeemable codes to end-users (e.g., for purchase or as a gift) who can then redeem the codes to acquire digital media assets from an online media store. Another advantage of the invention is that the redeemable codes can be content specific codes (for acquisition of specific digital media assets). Still another advantage of the invention is that a financial management system can track distribution, payment redemption, return and/or royalties for redeemable codes.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for providing codes that can be redeemed for products, said method comprising:
electronically receiving a request for one or more redeemable codes;
determining whether the request for the one or more redeemable codes is approved;
automatically generating one or more redeemable codes if it is determined that the request for the one or more redeemable codes is approved; and
electronically transmitting the one or more generated codes in response to the request.

2. A computer-implemented method as recited in claim 1, wherein the one or more generated codes are content specific codes that are redeemable for specific products.

3. A computer-implemented method as recited in claim 1, wherein the products are digital media assets.

4. A computer-implemented method as recited in claim 3, wherein the one or more generated codes are content specific codes that are redeemable for specific digital media assets.

5. A computer-implemented method as recited in claim 1, wherein the request for the one or more redeemable codes is from a requester, wherein said electronically transmitting of the one or more generated codes transmits the one or more generated codes to the requester, and
wherein said method further comprises:
receiving conformation of receipt of the one or more generated codes by the requestor; and
reporting distribution of the one or more generated codes to a financial management system.

6. A computer-implemented method as recited in claim 5, wherein the products are digital media assets, and wherein the one or more generated codes are content specific codes that are redeemable for specific digital media assets.

7. A computer-implemented method as recited in claim 5, wherein said method further comprises:
invoicing the requester for price of the one or more generated codes that have been received by the requester.

8. A computer-implemented method as recited in claim 5, wherein said method further comprises:
processing a return of at least one of the one or more generated codes.

9. A computer-implemented method as recited in claim 8, wherein said processing of the return comprises providing the requester with a credit for the return of the at least one of the one or more generated codes.

10. A computer-implemented method as recited in claim 8,
wherein a royalty obligation to a media distribution entity is associated with the at least one of the one or more generated codes, and
wherein said processing of the return comprises making an adjustment to royalties due to the media distribution entity due to the return of the at least one of the one or more generated codes.

11. A method as recited in claim 5, wherein said method further comprises:
paying a royalty obligation after receipt of the one or more generated codes by the requestor has been confirmed.

12. A computer-implemented method for providing codes that can be redeemed online for media items, said method comprising:
providing to a partner an electronic media catalog pertaining to a plurality of media items;
receiving an availability request from the partner regarding one or more specified media items;
sending to the partner availability and price data for the one or more specified media items;
receiving, from the partner, a request for one or more redeemable codes at a price indicated by the price data, each of the one or more redeemable codes being redeemable for one of the specified media items;
determining whether the one or more specified media items are available from an online media repository;
determining whether the price associated with the request for one or more redeemable codes is authentic;
automatically generating one or more redeemable codes if it is determined that the one or more specified media items are available from the online media repository and that the price associated with the request for one or more redeemable codes is authentic; and
electronically transmitting the one or more generated codes in response to the requester.

13. A computer-implemented method as recited in claim 12, wherein the one or more generated codes are content specific codes that are redeemable at an online media store for specific media items.

14. A computer-implemented method as recited in claim 12,
wherein the price data sent to the requester includes a digital signature for authentication,
wherein the price data included with the request for one or more redeemable codes for the one or more specified media items comprises the digital signature of the price data, and
wherein said determining whether the price associated with the request for one or more redeemable codes is authentic comprises validating the digital signature of the price data.

15. A computer-implemented method for redeeming a code for a digital media asset, said method comprising:
receiving a particular code to be redeemed from a code holder, the particular code corresponding to a specific digital media asset;
determining whether the particular code is valid;
determining whether the particular code has been previously redeemed; and
facilitating download of the specific digital media asset to the code holder if the particular code is determined to be valid and not previously redeemed.

16. A method as recited in claim 15, wherein said method further comprises:
notifying a financial management system that the particular code has been redeemed.

17. A method as recited in claim 16, wherein the financial management system notes that a royalty obligation is due unless the royalty obligation for the specific digital media asset code was already paid.

18. A method as recited in claim 16, wherein said method further comprises:
paying a royalty obligation after the particular code has been redeemed for the specific digital media asset.

19. A method as recited in claim 15, wherein the particular code is received via a redemption screen that is displayed with a code entry box for entry of the particular code.

20. A computer readable medium including at least executable computer program code tangibly stored thereon for providing codes that can be redeemed for products, said computer readable medium comprising:
computer program code for electronically receiving a request for one or more redeemable codes;
computer program code for determining whether the request for the one or more redeemable codes is approved;
computer program code for automatically generating one or more redeemable codes if it is determined that the request for the one or more redeemable codes is approved; and
computer program code for electronically transmitting the one or more generated codes in response to the request.

21. A system for distribution of redeemable codes, said system comprises:
a code server that provides online access to redeemable codes, said code server being configured to receive a request for one or more redeemable codes, generate one or more redeemable codes, and send the one or more generated codes in response to the request; and
a financial management system that tracks information regarding usage of the one or more redeemable codes.

22. A system as recited in claim 21,
wherein said code server is further configured to determine whether the request for the one or more redeemable codes is approved, and
wherein said code server generates and sends the one or more generated codes if the request for the one or more redeemable codes is approved.

23. A system as recited in claim 21, wherein the one or more redeemable codes are content specific codes that are redeemable for specific digital media assets.

24. A computer-implemented method as recited in claim 21,
wherein a end-user acquires one of the one or more redeemable codes at a first online store, and
wherein the end-user utilizes the one of the one or more redeemable codes at a second online store.

25. A system as recited in claim 21,
wherein said financial management system manages billing to partners that have received a plurality of redeemable codes from said code server, and
wherein said system further comprises a media repository that stores at least information on media items available for acquisition from an online store.
